(19) United States
(12) Patent Application Publication
(10) Pub. No.: US 2003/0111497 A1
(43) Pub. Date: Jun. 19, 2003

(54) Body-supported personal paint container kit

(76) Inventor: Gary Lukaris, Kirkland, WA (US)

Correspondence Address: Dean A. Craine, P.S., 400 - 112th Ave. NE, Suite 140, Bellevue, WA, 98004, US

(21) Appl. No.: 10/318,561

(22) Filed: Dec. 13, 2002

Related U.S. Application Data
(60) Provisional application No. 60/341,665, filed on Dec. 15, 2001.

(51) Int. Cl. B65D 25/52; A01K 97/04; A01K 97/06; A45F 5/00; A45C 1/04; A45F 3/00; F41C 33/02; F42B 39/02

(52) U.S. Cl. 224/197; 224/666; 224/269

(57) ABSTRACT

A body-supported paint container kit comprising a bucket that selectively attaches to the work belt worn around the waist of a painter to free the painter's hands from holding the bucket, allowing the painter to safely paint while holding onto any ladder or scaffolding. A clip member is attached to the rear wall of the bucket. The rear wall of the bucket placed against the leg is concave in the preferred embodiment and designed to conform to the outer shape of the leg. Attached to the bucket is a removable lid that enables the bucket to be closed thereby preventing paint located inside the bucket from drying out. The kit also includes a removable inner sleeve member and an exchangeable screen that fit inside the bucket. The inner sleeve includes a converging lower opening with outer edges designed to allow the tip of a paint brush to be dipped into the paint and located in the bucket and then pulled over the lower edge of the inner sleeve to facilitate removal of excess paint from the paint brush.

This utility patent application claims the benefit of provisional patent application (Serial No. 60/341,665) filed on Dec. 15, 2001.

### BACKGROUND OF THE INVENTION

1. Field of the Invention

This invention pertains to package and article carriers, and more particularly, to paint containers designed to be carried by the user.

2. Description of the Related Art

Painting with a paint brush, despite advancements in the field, is still an awkward and messy endeavor, even for professionals. The usual method of holding the manufacturer's paint can in a stable position, dipping the paint brush therein, and removing the excess paint from the brush by wiping the brush against the inner lip of the paint bucket has several drawbacks. One such disadvantage is that using this method, the bucket must be manually carried or continuously moved to a new area as the work is completed. Many of the drawbacks of traditional paint can methods involve the inconvenience of excessive things to carry as well as monitoring their whereabouts.

Climbing and descending the ladder with a paint bucket and a wet paint brush is usually accomplished by holding the bucket and paint brush in one hand, and holding on to the ladder with the other. This is undesirable, however, because of the danger involved in using only one hand to move about on a ladder. Carrying the wet brush inside the paint can may seem workable if the level of paint is sufficiently low, but is still less than ideal because the handle usually contacts wet paint on the inner walls of the paint bucket. Holding the wet brush and the paint can with one hand often results in unintentional paint splotches and drips on clothing and other surfaces.

While painting on the ground or from a stepladder, some painters prefer to carry the bucket in one hand and paint with the other rather than repeatedly bending to access the paint bucket located on the ladder shelf. Dipping the brush into the paint bucket while holding the paint can bail can be difficult, and can result in compromised attention to detail and safety. Both methods can be very tiresome, and many painters would prefer to have their second hand free if at all possible, especially in the case of a painter who needs to hold onto scaffolding.

Another drawback of painting from the manufacturer's paint can is that paint located along the sides of the can where the paint is least agitated will dry out relatively quickly. Also, as the brush is wiped along the top edge of the can, paint often drips into the circular slot formed on the top edge of the can used to engage the lid thereby preventing the lid from being tightly reattached to the can.

What is needed is a bodily-carried paint container that temporarily holds a sufficient amount of paint, is pivotally adjustable on a work belt so that the user may bend over without spilling paint therefrom, that allows the user to use both hands while carrying the container, that enables the user to easily remove excess paint from the brush while painting, and can be closed to prevent the paint stored therein from drying out.

### SUMMARY OF THE INVENTION

It is an object of the present invention to provide a bodily-supported paint container kit.

It is a further object of the present invention to provide such a paint container kit that attaches to the user's waist and is suspended a sufficient distance from the body to minimize unintentional contact of the wet paintbrush with clothing and skin during use.

It is another object of the present invention to provide such a paint container kit with means located inside an inner bucket that enables excess paint to be easily removed from the brush.

It is another object of the present invention to provide such a paint container kit that includes a bucket that conforms to the user's leg thereby allowing the user to walk, climb ladders and bend without spilling paint.

It is another object of the present invention to provide such a paint container kit that temporarily holds the paintbrush in an upright position inside the bucket.

It is a further object of the present invention to provide such a paint container kit that is closeable to prevent paint temporarily stored inside from drying out.

These and other objects of the present invention are met by a body-supported paint container kit comprising a paint bucket attached to a clip that selectively attaches to a belt worn around the waist of a painter. The rear wall of the bucket is concave and designed to conform to the outer shape of the leg when suspended from the clip. In that embodiment, the clip is pivotally attached to a bucket. A removable inner sleeve member nests inside the bucket and includes converging side walls and a lower opening designed to facilitate removal of excess paint from the brush and to hold the paintbrush upright within the bucket. The kit also includes an optional screen that may be used in place of the inner sleeve member to enable the bucket to be used with a roller.

The paint bucket is designed to hold one to two quarts of paint and includes a removable lid that closes the bucket, preventing paint located inside the paint bucket from drying out. The bucket is designed to store a standard 2 to 4 inch wide paint brush in an upright position when the lid is closed on the bucket. The bucket may only include an optional recessed bottom designed to receive and securely hold the removable lid so that the lid is always available to close the bucket. In one embodiment, the clip is removably attached to a laterally extending neck formed on the rear wall of the bucket. The length of the neck or clip are sufficient so that the top opening of the bucket is spaced apart from the user's waist to allow the user to gain better access to the top opening and prevent contact of the brush with the user's clothes when carried on the user's waist.

### DESCRIPTION OF THE DRAWINGS

FIG. 1 is an exploded perspective view of the personal paint container.

FIG. 2 is a rear elevational view of the invention.

FIG. 3 is a right side sectional view of the invention taken along line 3-3 in FIG. 2.

FIG. 4 is a top plan view of the invention.

FIG. 5 is a perspective view of a removable screen used with the kit.

FIG. 6 is a front elevational view of the container used with a roller.

FIG. 7 is a perspective view of a second embodiment of the bucket.

FIG. 8 is a rear elevational view of the bucket shown in FIG. 7.

FIG. 9 is a side elevational view of the bucket shown in FIG. 7.

FIG. 10 is a top plan view of the bucket.

FIG. 11 is a rear elevational view of the post formed on the rear surface of the bucket.

FIG. 12 is a side elevational view of the post shown in FIG. 12.

FIG. 13 is a perspective view of the belt clip.

FIG. 14 is a front plan view of the belt clip.

FIG. 15 is a side elevational view of the belt clip.

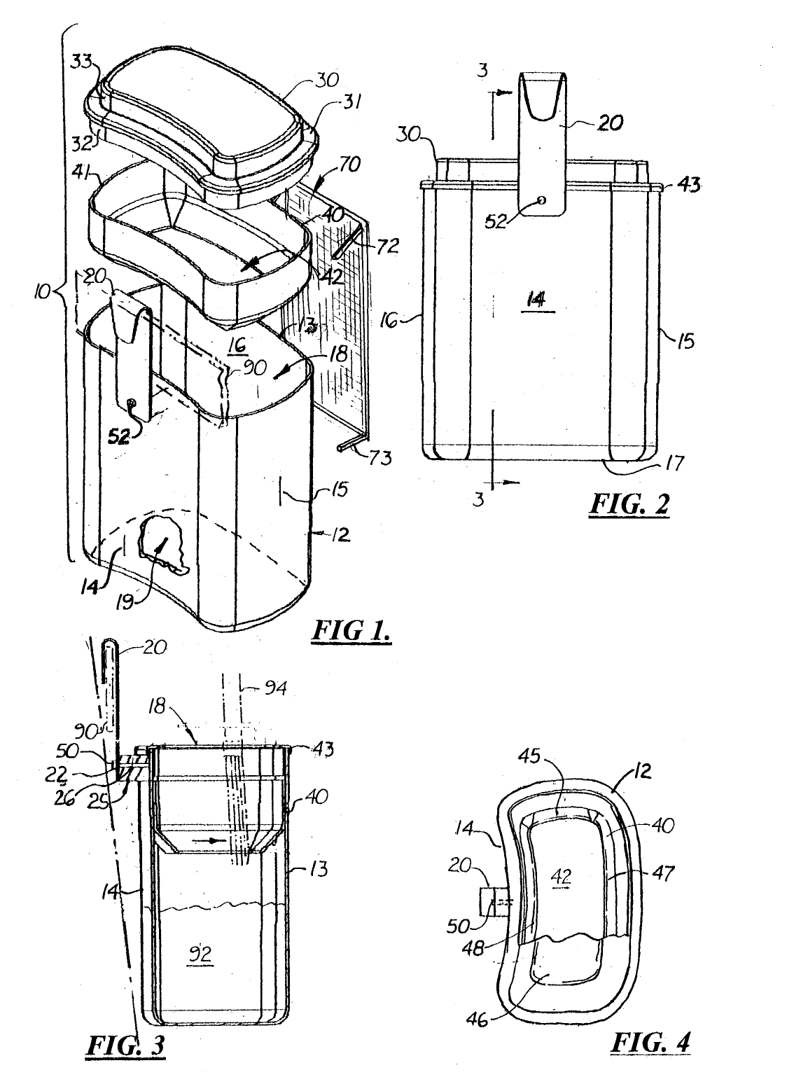

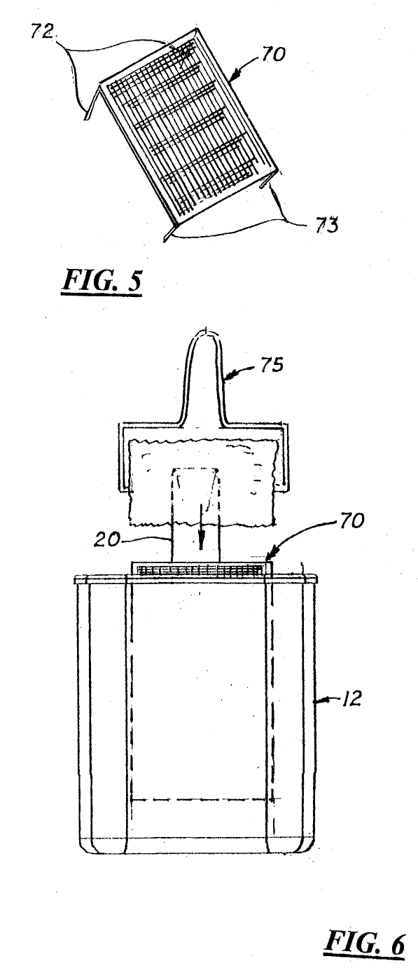

### DESCRIPTION OF THE PREFERRED EMBODIMENT(S)

Referring to the accompanying Figs., there is shown and described a personal paint container 10 comprising a paint bucket 12 pivotally attached to a removable clip 20 that selectively attaches to a belt 90 worn around the waist of a painter. The bucket 12 comprises a front wall 13, a rear wall 14, two side walls 15, 16, a bottom surface 17, a top opening 18 and an inside storage space 19. The rear wall 14 of the bucket 12 is concave and designed to conform to the outer shape of a leg when the clip 20 is attached to the a 90 and the bucket 12 is suspended from the clip 20 adjacent to the leg. The bucket 12 includes a lid 30 that is removably held to the top or bottom of the bucket 12 that enables the bucket 12 to be closed thereby preventing paint 92 located therewithin from drying out. The bucket 12 also includes a removable inner sleeve member 40 that fits inside the bucket 12 and includes a lower opening 42 with four converging side walls 45-48 designed to hold a paint brush 94 upright when placed therein and to facilitate removal of excess paint 92 from the brush 94.

Formed near the upper edge of the rear wall 14 on the bucket 12 is a laterally extending neck 25. In the embodiment shown in the Figs., a pin 50 extends centrally through the neck 25 and is used to removably attach the clip 20 to the rear wall 14 of the bucket 12. The pin 50 is inserted through bores 22, 26 formed in the distal end of the clip 20 and neck 25, respectively. The pin 50 frictionally engages the bores 22, 26 to prevent the clip 20 and bucket 12 from disengaging from the pin 50. It should be understood that the pin 50 could be rigidly mounted on the neck 25. During operation, the clip 20 is allowed to pivot around the pin 50 so that the bucket 12 may pivot on the user's belt to accommodate movement of the painter and avoid spillage of paint 92.

In the preferred embodiment, a neck 25 is sufficient in length so that the bucket 12 hangs from the belt 90 at an angle on the side of the painter's leg or hip thereby positioning the top opening 18 away from the user's leg. By separating the top opening 18 from the waist, the user has better access to the top opening 18 with a paint brush 94, and the paint brush 94 is less likely to touch or rub up against the painter's clothes during use.

An inner sleeve 40 is disposed within the bucket 12 to act as a wiping surface for the paint brush and also as a support means to temporarily hold the paint brush 94 in a vertical position within the bucket 12. The inner sleeve 40 has upper vertical walls 41 that correspond in shape with the side walls 15, 16 of the bucket 12 but have a slightly smaller periphery to allow the inner sleeve 40 to nest tightly inside the bucket 12. An outer lip 43 is formed on the top edges of the vertical walls 41 on which suspends the inner sleeve 40 vertically within the inside storage space 19.

The lower four converging side walls 45-48 formed on the inner sleeve 40 create a converging, rectangular-shaped lower opening 42 sufficient in size to allow a paint brush 94 to be inserted and removed therethrough fairly easily. Paint 92 wiped on the converging lower edges 45-48 is directed by the lower side walls 45-48 to drip towards a more central region of the top surface of the paint 92 located in the bucket 12, where it is less likely to dry out than if it were wiped along a side wall 15, 16 of the bucket 12.

The four converging side walls 45-48 also act as support surfaces for the paint brush 94 when it is stored in a vertical position inside the bucket 12. The side walls 45-48 also hold the paint brush upright to prevent the upper portion of the paint brush 94, where a painter's hand will contact the brush handle, from touching the vertical walls 41 which may be covered with wet paint.

A lid 30 is removably disposed over the inner sleeve 40 and bucket 12. The lid 30 has downward extending vertical walls 32 that correspond in shape with the vertical walls 41 of the inner sleeve 40 but have a slightly smaller periphery to allow walls 32 to nest tightly inside the top opening of the inner sleeve 40. The lid 30 has a lip 31 disposed around the outer periphery of the lid 30 to allow the lid 30 to rest over the inner sleeve 40 and top opening 18. The lid 30 includes an upward extending lid portion 33 that acts as a gripping surface for ease in handling. In one embodiment, the lid 30 is designed to fit into an optional lower recessed space 28 formed on the bucket 12.

The kit also includes a screen 70 that is used in place of the inner sleeve 40 and used with a four-inch roller 75. The screen 70 includes an upper set of diagonally aligned legs 72 and a lower set of perpendicularly aligned legs 73.

The bucket 12 has sufficient length and width so that a standard 4″ paint brush 94 may be disposed vertically in the bucket 12. During use, a paint brush 94 may be temporarily held in a vertical position inside the bucket 12. When one quart of paint 92 is placed inside the bucket 12, the depth of the paint 92 is sufficient to cover approximately the lower two inches of the brush's bristles. This feature allows a painter to leave the paint brush 94 inside the bucket 12 with the bristles partially covering the lower portion of the paint brush 94.

The overall length and width of the bucket 12 is sufficient so that it may hold one to two quarts of paint 92 weighing approximately 1.5 to 3 lbs. The height of the container 10 is also sufficient so that one to two quarts of paint 92 only covers two to three inches of the bristles when the paint brush 94 is vertically disposed inside the container 10. The opening 42 of the sleeve 40 is also sufficient to be used with a four-inch paint brush 94. The container 10 is made of lightweight polyethylene, a non-porous material that allows for easy cleaning.

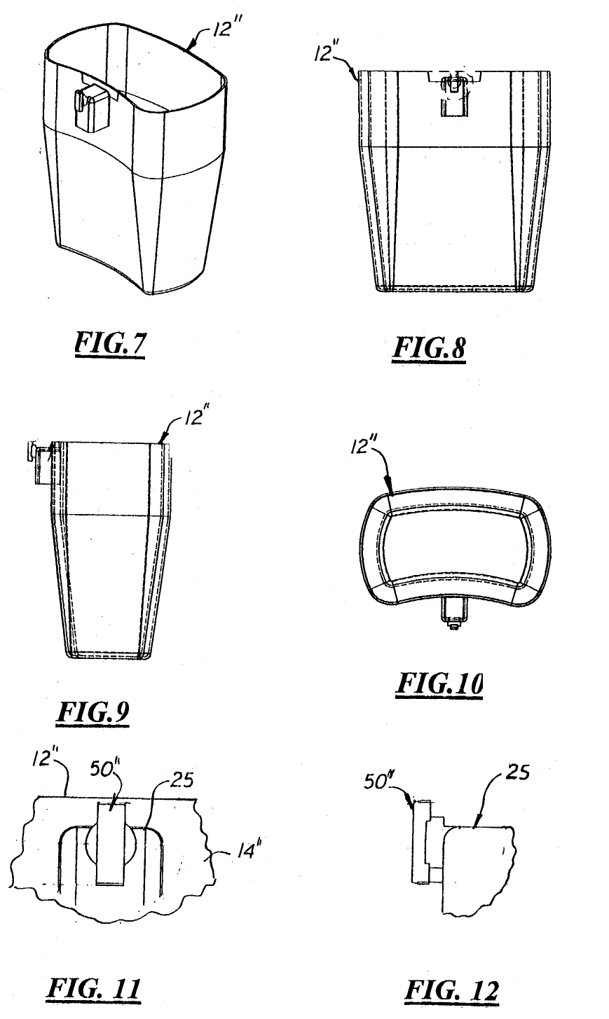

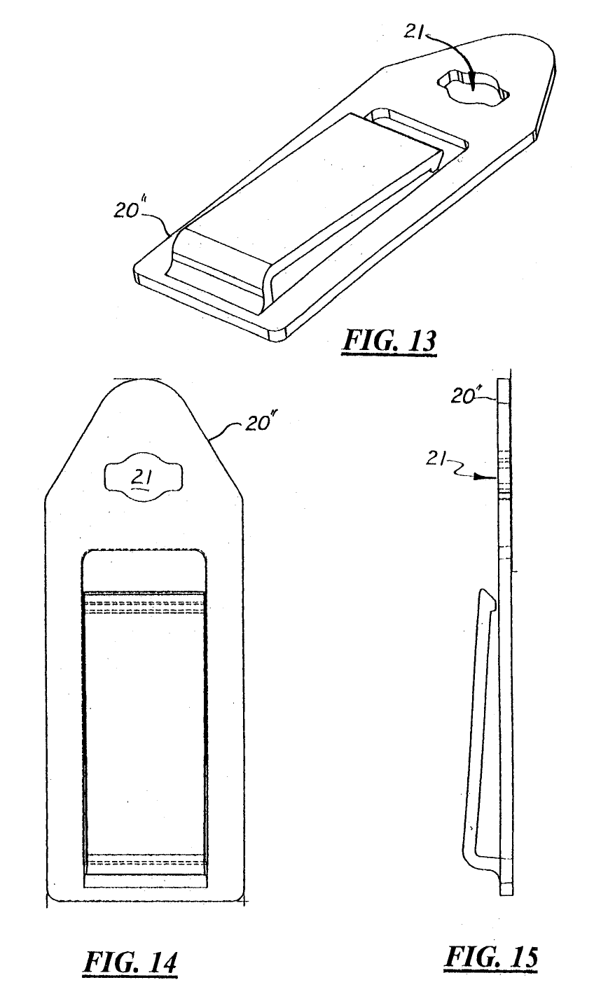

In FIGS. 7-10, there is shown a second embodiment of the bucket 12″ that is tapered along its four sides 13″-16″ so that it may easily be stacked for easier distribution. Attached to the rear surface of the bucket is a flexible belt clip shown more clearly in FIGS. 13-14. The flexible belt clip includes a slotted hole through which a pin 50 formed on the rear surface of the bucket 12 (shown more clearly in FIGS. 11 and 12). During assembly, the flexible belt clip 20 is rotated 90 degrees and distorted in shape so that the pin 50 may be inserted into the slotted hole. When the flexible belt clip 20 returns to its original shape and rotates vertically over the pin 50, the clip 20 is permanently retained on the clip 20.

During use, the lid 30 is removed from the bucket 12. One to two quarts of paint 92 is then poured into the bucket 12. The clip 20 is then attached to the user's belt 90 to suspend the container 10 therefrom. The painter may use up to a four-inch brush 94 with the container 10.

When a painter desires to use a two- to four-inch roller 75, the inner sleeve member 40 is removed and replaced with the screen 70. The screen 70 is vertically aligned inside the bucket 12 with the two upper diagonal legs 72 extended over the upper edge of the bucket 12 and the lower legs 73 resting against the inside surface of the bucket 12. The upper legs 72 engage the top edge of the bucket 12 to hold the screen 70 in a vertically aligned position inside the bucket 12.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A body-supported paint container kit, comprising:
a. a bucket with a front wall, a rear wall, two side walls, a bottom and a top opening;
b. a clip member attached to said rear wall of said bucket to attach said bucket to a belt worn by a user;
c. a sleeve member disposed inside said paint container, said sleeve member including a converging lower opening that allows a paint brush to be inserted therein to contact paint located inside said bucket and below said converging lower opening and then withdrawn therefrom to facilitate removal of excess paint from said paint brush; and,
d. a lid removably attached over said top opening of said bucket.

2. The body-supported paint container kit, as recited in claim 1, wherein said clip member is pivotally attached to said bucket.

3. The body-supported paint container kit, as recited in claim 1, further including a screen that fits into said bucket.

4. The body-supported paint container kit, as recited in claim 2, further including a screen that fits into said bucket.

5. The body-supported paint container kit, as recited in claim 1, wherein said rear wall is concave to allow said bucket to be placed against a user's leg.

6. The body-supported paint container kit, as recited in claim 2, wherein said rear wall is concave.

7. The body-supported paint container kit, as recited in claim 3, wherein said rear wall is concave to allow said bucket to be placed against a user's leg.

8. The body-supported paint container, as recited in claim 1, wherein said bottom is recessed to selectively receive said lid.

9. The body-supported paint container kit, as recited in claim 1, further including a laterally extending neck disposed between said bucket and said clip member which positions said bucket spaced-apart from the user.

10. The body-supported paint container kit, as recited in claim 1, wherein said lower opening on said sleeve member is rectangular.

11. The body-supported paint container kit, as recited in claim 1, wherein said bucket has sufficient height to store a longitudinally aligned paint brush therein when said lid is closed on said bucket.

12. A body-supported paint container kit, comprising:
a. a bucket with a front wall, a concave rear wall, two side walls, a bottom and a top opening, and a recessed space located under said bottom;
b. a clip member pivotally attached to said rear wall of said bucket to attach said bucket to a belt worn by a user;
c. a sleeve member disposed inside said paint container, said sleeve member including a converging lower opening that allows a paint brush to be inserted therein to contact paint located inside said bucket and below said converging lower opening and then withdrawn therefrom to facilitate removal of excess paint from said paint brush; and,
d. a lid removably attached over said top opening of said bucket.

13. The body-supported paint container kit, as recited in claim 12, further including a laterally extending neck disposed between said bucket and said clip member which positions said bucket spaced-apart from the user.

14. The body-supported paint container kit, as recited in claim 12, wherein said lower opening on said sleeve member is rectangular.

15. The body-supported paint container kit, as recited in claim 12, further including a screen that fits into said bucket.

16. The body-supported paint container kit, as recited in claim 12, wherein said front wall, rear wall, and side walls are tapered so that said bucket may be longitudinally aligned and stacked together with other buckets.
